(19) United States
(12) Patent Application Publication
(10) Pub. No.: US 2018/0344095 A1
(43) Pub. Date: Dec. 6, 2018

(54) Choppii

(71) Applicants: Eduardo Antonio Nunez, (US); Fernando Cuellar, (US)

(72) Inventors: Eduardo Antonio Nunez, Brownsville, TX (US); Fernando Cuellar, Brownsville, TX (US)

(73) Assignee: Eduardo Nunez, Brownsville, TX (US)

(21) Appl. No.: 15/613,411

(22) Filed: Jun. 5, 2017

Related U.S. Application Data
(63) Continuation of application No. 15/427,834, now abandoned.

(51) Int. Cl. A47J 47/00; B60R 11/00

(52) U.S. Cl. CPC A47J 47/005; B62D 33/0273; B60R 11/00

(57) ABSTRACT

A plain nonstick surface made of Polyethylene material. Attachable/Removable to pickup trucks tailgate. Properly secure to the original pickup truck's screw holes. It includes a knife holder or knife magnet, sharpening stone, can holder and measuring rule. Custom made to adapt to any size and shape of the tail gate.

### BACKGROUND

People who enjoy hunting or fishing typically have to bring their felled game and fish home or to a butcher shop in order to get it cleaned, cut, chopped, and the like. Having to travel with felled animals or numerous caught fish can be an inconvenient, frustrating, and unpleasant experience. People who enjoy tailgating may not have enough space available in order to prep and serve food. Being able to utilize the truck's tailgate as a cutting board or prep board surface could be beneficial for all outdoor enthusiast

### BRIEF SUMMARY OF THE INVENTION

Choppii is an oversized cutting board capable of being attached to pick up truck's tailgate, enabling users to chop, cut, filet, prep and/or serve numerous types of food or animals while outdoors. The device is bolted directly onto the tailgate using the original fastening screw, firmly securing the board for use.

Permanently becomes an accessory for the pickup truck once installed, eliminating the need to constantly remove and reinstall the device when an individual needs to cut, chop, or otherwise prepare food.

Features a measuring rule, knife storage slots (or Magnet) a removable sharpening block, and cup holders for added convenience, keeping all necessary cutting tools readily available.

### DESCRIPTION OF DRAWINGS

FIG. 1 shows the device in use at a tailgate.

FIG. 2 illustrates the cutting board being used to prepare food

FIG. 3 shows how the cutting board can be bolted onto the tailgate.

FIG. 4 shows the device being wiped clean with ease.

FIG. 5 shows a standalone view of the cutting board propped up against a tailgate

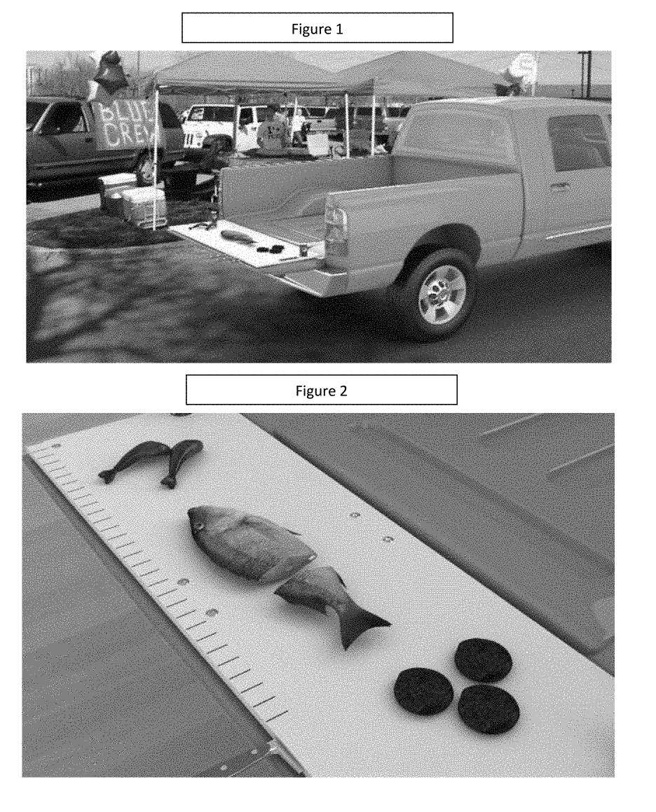

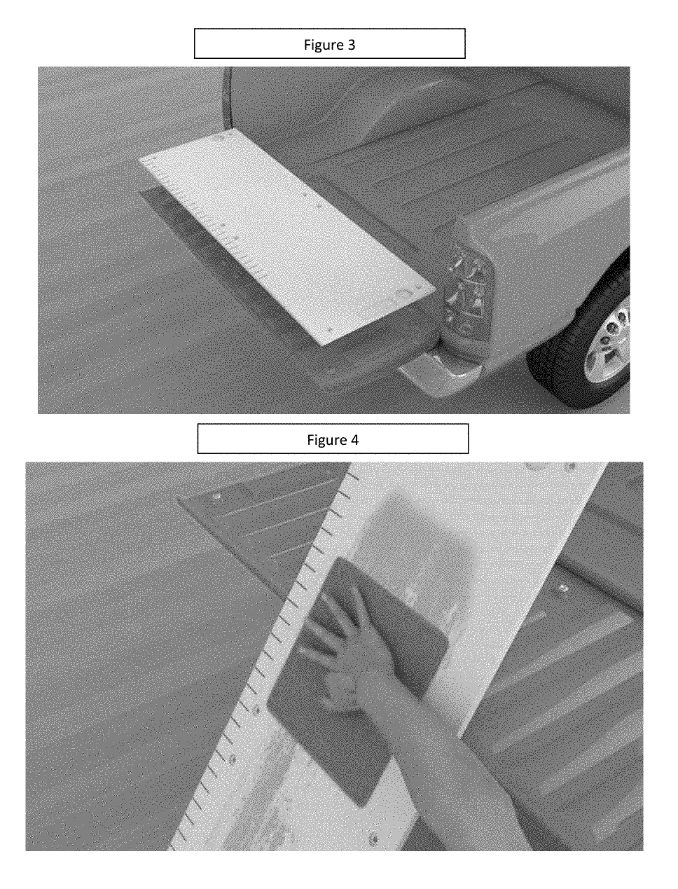

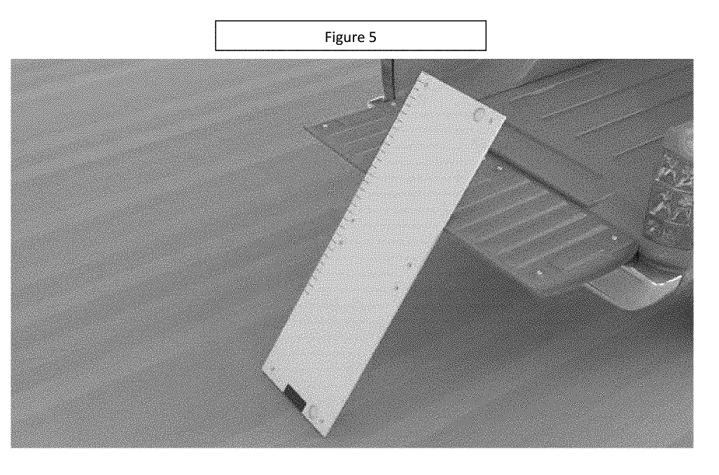

### DETAILED DESCRIPTION AND BEST MODE OF IMPLEMENTATION

Choppii is a modified and oversized cutting board surface screwed onto a pickup truck tailgate, providing outdoor enthusiasts and tailgaters with a food prep and cutting surface. The device is comprised of a flat cutting board with numerous screw matching the original tailgate screw holes on the back of a pickup truck bed. The cutting board can be installed using the original screws on the tailgate, firmly securing it to the back of the truck.

The surface of the cutting board can feature a measuring rule, Knife storage slots (or holding magnet strip), a removable knife sharpening block and holder, cup holder, and other accessory items or spaces. Each of these features is intended to offer further convenience for the user as he/she cuts and prepares animals/food. The surface of the cutting board features a non-stick material (approved by the FDA) making it easy to wipe down and rinse. No need to unmount for cleaning.

Choppii board is made of (FDA approved) and other food-safe materials. It may also include longer screws specifically design to fit any size, make, and model of pickup truck tailgate. Exact size, measurements, construction, and design specifications may vary upon manufacturing.

Choppii is a custom made accessory. Built on customer specifications. However, the thickness of the board will be set to 3 measurements: ½ in, ¾ in, 1 in MAX.

1. A Truck Tailgates attachable cutting board comprising:
(a) Of non-stick Polyethylene material;
(b) Attachable and removable, using original Tailgates' screw holes;
(c) Includes a knife holder or knife magnet, sharpening stone, can holders and measurement rule.
(d) Standard thickness measurement of ½ in, ¾ in, 1 in MAX.
